(19) United States
(12) Patent Application Publication
(10) Pub. No.: US 2017/0169274 A1
(43) Pub. Date: Jun. 15, 2017

(54) SANDWICH TYPE FINGERPRINT RECOGNITION DEVICE

(71) Applicant: CentraLED Technology Co., Ltd., Taoyuan (TW)

(72) Inventors: Ching-Cherng SUN, Taoyuan (TW); Yeh-Wei YU, Taoyuan (TW); Liang-Zhu YU, Taoyuan (TW)

(21) Appl. No.: 15/373,000

(22) Filed: Dec. 8, 2016

Related U.S. Application Data
(60) Provisional application No. 62/309,504, filed on Mar. 17, 2016.
(60) Provisional application No. 62/309,515, filed on Mar. 17, 2016.
(60) Provisional application No. 62/265,467, filed on Dec. 10, 2015.

(51) Int. Cl. G06K 9/00

(52) U.S. Cl. CPC G06K 9/0004; G06K 9/00087

(57) ABSTRACT

The present invention discloses sandwich type fingerprint recognition devices, one embodiment of the sandwich type fingerprint recognition device includes a first transparent layer, a spatial filter layer with multiple through holes, a second transparent layer and an optical sensor. Another embodiment of the sandwich type fingerprint recognition device includes a first transparent layer, a spatial filter layer with multiple through holes and an optical sensor. With the implementation of the present invention, complex production process or equipment are not required for producing fingerprint recognition device that reduce costs; the size of the fingerprint recognition device is reduced; a variety of thickness choices for the first transparent layer or second transparent layer and a variety of colors can be used and more applications are thus possible; and the contrast of fingerprint signal is enhanced to enable clarifying fingerprint features and characteristics and thus recognition accuracy of fingerprints.

### BACKGROUND OF THE INVENTION

1. Technical Field

The present invention relates to fingerprint recognition devices, and more particularly to sandwich type fingerprint recognition devices.

2. Description of Related Art

Traditional optical fingerprint recognition system or device uses an imaging system to acquire the image of fingerprint. Due to the bulk size of traditional device or system, positive lens can be adopted to commence imaging in the imaging system.

However, as the increasingly widespread of the fingerprint recognition system or device to handheld or portable devices that is relatively small in size, the space reserved for fingerprint recognition system or device becomes quite small.

Therefore, when adopting fingerprint recognition system or device to apparatus relatively small, positive lens imaging method cannot be applied due to such physical limitation.

It is therefore highly desirable to have the development of a thin type, high imaging quality fingerprint recognition device with multi-layer spatial filter and pillar structure to apply in limited space in thin or small size portable or mini devices or smart handheld devices.

### BRIEF SUMMARY OF THE INVENTION

The present invention discloses sandwich type fingerprint recognition devices, one embodiment of the sandwich type fingerprint recognition device includes a first transparent layer, a spatial filter layer with multiple through holes, a second transparent layer and an optical sensor. Another embodiment of the sandwich type fingerprint recognition device includes a first transparent layer, a spatial filter layer with multiple through holes and an optical sensor. With the implementation of the present invention, complex production process or equipment are not required for producing fingerprint recognition device that reduce costs; the size of the fingerprint recognition device is reduced; a variety of thickness choices for cover glass (first transparent layer or second transparent layer); a variety of colors can be used and more applications are thus possible; and the contrast of fingerprint signal is enhanced to enable clarifying fingerprint features and characteristics and thus recognition accuracy of fingerprints.

The present invention provides a sandwich type fingerprint recognition device, being a multi-layer structure used to sense or recognize a fingerprint, comprising: a first transparent layer, being made of light transmitting substance, includes an upper surface and a lower surface opposite to the upper surface, wherein the thickness of the first transparent layer is in the range from 1 micrometer to 800 micrometer; a filter layer, being formed on the lower surface; and an optical sensor, being fixedly provided beside the filter layer in a way that the filter layer being in between the first transparent layer and the optical sensor.

The present invention provides another sandwich type fingerprint recognition device, being a multi-layer structure used to sense or recognize a fingerprint, comprising: a first transparent layer, being made of light transmitting substance, includes an upper surface and a lower surface opposite to the upper surface, wherein the thickness of the first transparent layer is in the range from 1 micrometer to 800 micrometer; a filter layer, being formed on the lower surface; a second transparent layer, being formed on the filter layer in a way that the filter layer being sandwiched in between the first transparent layer and the second transparent layer; and an optical sensor, being fixedly provided beside the second transparent layer.

The present invention provides another sandwich type fingerprint recognition device, being a multi-layer structure used to sense or recognize a fingerprint, comprising: a first transparent layer, being made of light transmitting substance, includes an upper surface and a lower surface opposite to the upper surface, wherein the thickness of the first transparent layer is in the range from 1 micrometer to 800 micrometer; a filter layer, being formed on the upper surface; and an optical sensor, being fixedly provided beside the lower surface.

Implementation of the present invention at least provides the following advantageous effects:

1. Structure simplicity to ensure ease of manufacturing and to reduce manufacturing costs.

2. Reduction of space occupation enabling further applications.

3. Provides high resolution and accurate fingerprint recognition

4. Applicable to filling of material or materials of a variety of colors.

5. Capable of enhancing the contrast of fingerprint signal.

6. Capable of enhancing the discrimination of characteristics of fingerprint signal and preventing false recognition.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a structural perspective view of a sandwich type fingerprint recognition device in an embodiment of the present invention.

FIG. 2 is a structural perspective view of a sandwich type fingerprint recognition device in another embodiment of the present invention.

FIG. 3 is a structural perspective view of a sandwich type fingerprint recognition device in still another embodiment of the present invention.

FIG. 4A is a longitudinal perspective section view of a filter layer in an embodiment of the present invention.

FIG. 4B is a lateral perspective section view of a filter layer in an embodiment of the present invention.

FIG. 5 is a sectional perspective view of the optical sensor being not in contact with the filter layer in the embodiment of FIG. 1.

FIG. 6 is a sectional perspective view of the optical sensor being not in contact with the second transparent layer in the embodiment of FIG. 2.

FIG. 7 is a sectional perspective view of the optical sensor being not in contact with the first transparent layer in the embodiment of FIG. 3.

FIG. 8 is a structural perspective view of a sandwich type fingerprint recognition device further comprises a pillar layer in an embodiment of the present invention.

FIG. 9 is a structural perspective view of a sandwich type fingerprint recognition device further comprises a pillar layer in another embodiment of the present invention.

FIG. 10A is a structural perspective view of a filter layer in an embodiment of the present invention.

FIG. 10B is a structural perspective view of a filter layer in another embodiment of the present invention.

FIG. 10C is a structural perspective view of a filter layer in still another embodiment of the present invention.

### DETAILED DESCRIPTION OF THE INVENTION

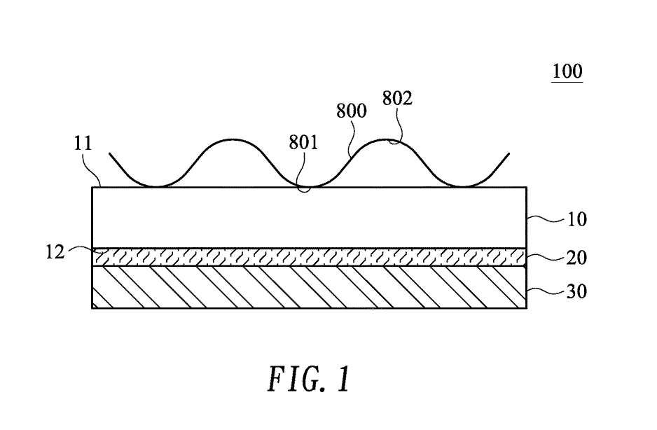

Please refer to FIG. 1, an embodiment of a sandwich type fingerprint recognition device 100 comprises: a first transparent layer 10, a filter layer 20 and an optical sensor 30.

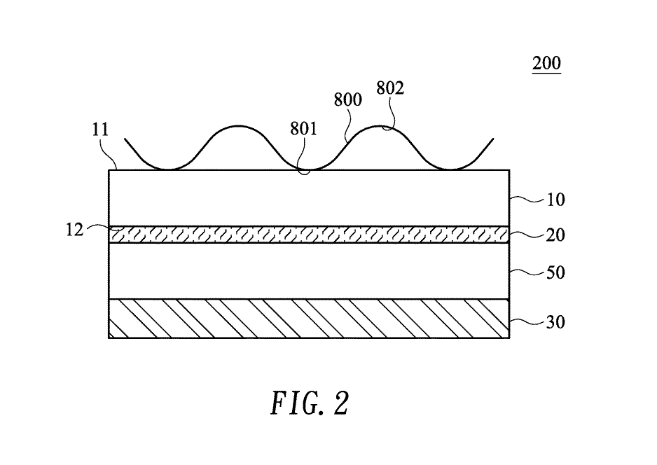

As shown in FIG. 2 is another sandwich type fingerprint recognition device 200, which comprises: a first transparent layer 10, a filter layer 20, a second transparent layer 50 and an optical sensor 30.

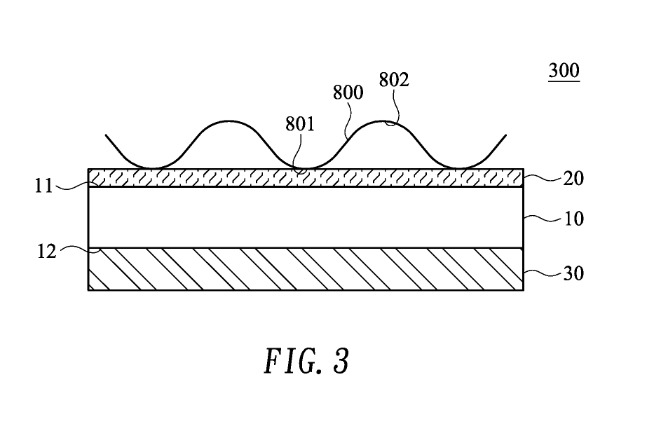

Further shown in FIG. 3 is still another sandwich type fingerprint recognition device 300, which comprises: a first transparent layer 10, a filter layer 20 and an optical sensor 30.

As shown in FIG. 1 to FIG. 3, the first transparent layer 10 of the sandwich type fingerprint recognition device 100, or of the sandwich type fingerprint recognition device 200, or of the sandwich type fingerprint recognition device 300 can be a transparent plate or film made of glass or any material or materials transparent to light in visible frequency region, infrared frequency region or ultraviolet frequency region.

In applications of finger print recognition or detection, the thickness of the first transparent layer 10 can be chosen in the range from 1 μm to 800 μm.

As shown in FIG. 1 and FIG. 2, when in actual detection of fingerprint 800, the finger of a user with the fingerprint 800 to be detected or recognized or processed rests on the first transparent layer 10. The light reflected from at least one ridge portion 801 and at least one valley portion 802 of the fingerprint 800 passes through the first transparent layer 10 and reaches the filter layer 20 to be then modulated by the filter layer 20.

As shown in FIG. 3, while applying the sandwich type fingerprint recognition device 300, the finger of a user with the fingerprint 800 to be detected or recognized or processed rests on the first transparent layer 10 touching the filter layer 20, the light reflected from the ridge portion 801 and the valley portion 802 of the fingerprint 800 first being modulated by the filter layer 20 and then passes through the first transparent layer 10.

As shown in FIG. 1 to FIG. 3, the filter layer 10 of the sandwich type fingerprint recognition device 100, or of the sandwich type fingerprint recognition device 200, or of the sandwich type fingerprint recognition device 300 being used as a spatial filter that modulates incident light, which is the light signal reflected from the fingerprint 800, to suppress, isolate or reflect oblique incident portion of the incident light and enhance the contrast of the light signal.

As shown in FIG. 1 to FIG. 4B, the aforesaid filter layer 20 can be an optical film, plural microstructures or light blocking layer 20′ with plural through holes 21.

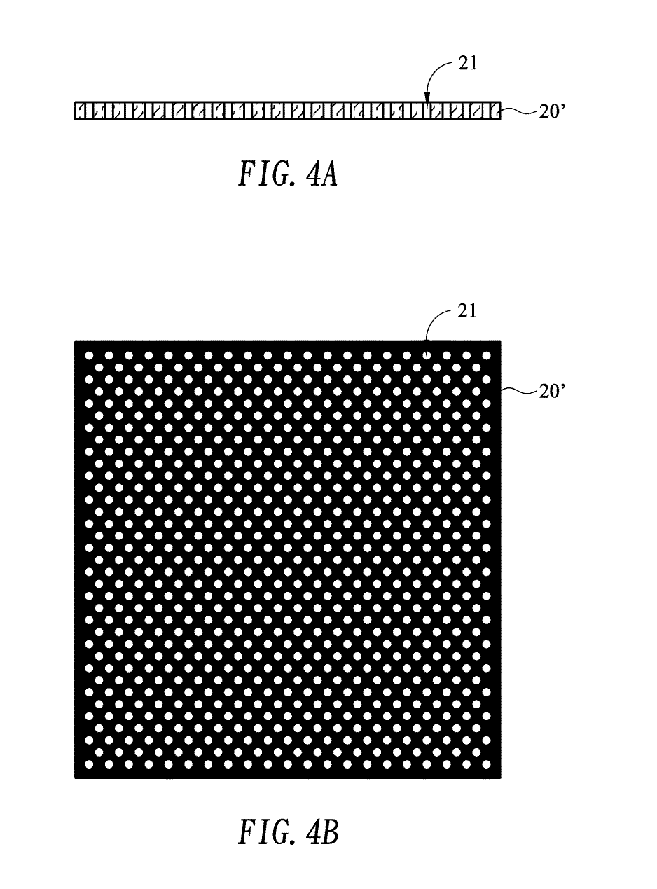

Referring to FIG. 4A and FIG. 4B, when light blocking layer 20′ with plural through holes 21 is used as the filter layer 20, only the light signal incidents to the through holes 21 will pass, other part of the light blocking layer 20′ blocks light signal in visible frequency region, infrared frequency region or ultraviolet frequency region.

In embodiments, transparent material or materials can be filled in the through holes 21 to make the filter layer 20 better endurable while the light still passes through the through holes 21. And on the other hand, the diameter of any of the through holes 21 can be made to be larger than 2 μm, or in between 2 μm and 100 μm.

Further, the surface of the filter layer 20 with through holes 21 can also be a light reflecting surface that reflects large angle oblique incident light to reduce its intensity of passing through the filter layer 20, thus reduces noise signal and enhance the contrast of the light signal reflected by fingerprint 800 and received by the optical sensor 50 in sandwich type fingerprint recognition device 100, sandwich type fingerprint recognition device 200 or sandwich type fingerprint recognition device 300.

And hence, the scattering of reflected light signal by fingerprint 800 that generates blur effect in the optical sensor 50 is reduced or even eliminated.

As shown in FIG. 2, FIG. 4A and FIG. 4B, the light blocking layer 20′ can be formed of colored structure of a specific color or specific colors with the effect that color of the overall appearance when observed from top of the sandwich type fingerprint recognition device 100, sandwich type fingerprint recognition device 200 or sandwich type fingerprint recognition device 300 is being changed or modified according to various applications.

Please refer to FIG. 2, the second transparent layer 50 can also be a transparent plate or film made of glass or any material or materials transparent to light in visible frequency region, infrared frequency region or ultraviolet frequency region.

The second transparent layer 50 is implemented attached to the filter layer 20 making the filter layer 20 being sandwiched between the second transparent layer 50 and the first transparent layer 10.

As for the thickness of the second transparent layer 50, it can also be chosen to be in the range from 1 μm to 800 μm.

With continuous reference to FIG. 1 to FIG. 3, optical sensor 30 is formed or implemented in under the first transparent layer 10 or under the filter layer 20, or under the sandwich structure of first transparent layer 10, the filter layer 20 and the second transparent layer 50.

The optical sensor 30 shown in FIG. 1 to FIG. 3 is used to receive the light signal reflected from at least one ridge portion 801 and at least one valley portion 802 of the fingerprint 800 that passes through the first transparent layer 10 and the filter layer 20 or the first transparent layer 10 and the filter layer 20 and the second transparent layer 50, and then generates a pattern light signal of the fingerprint 800 for post processing.

Further, the aforesaid optical sensor 30 can be composed of at least one optical sensor chip.

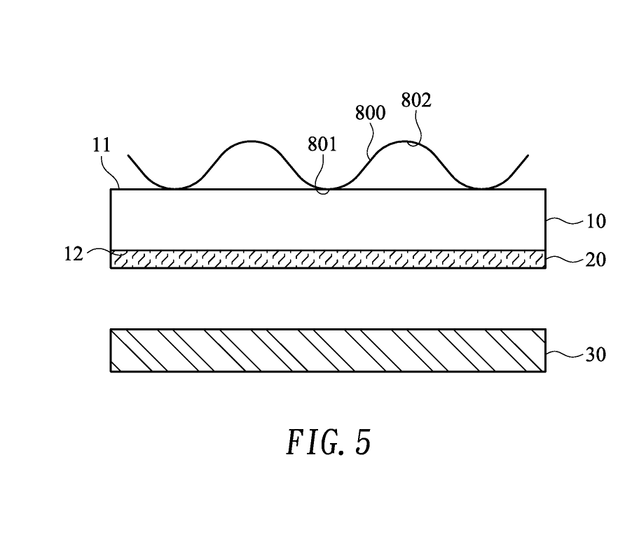

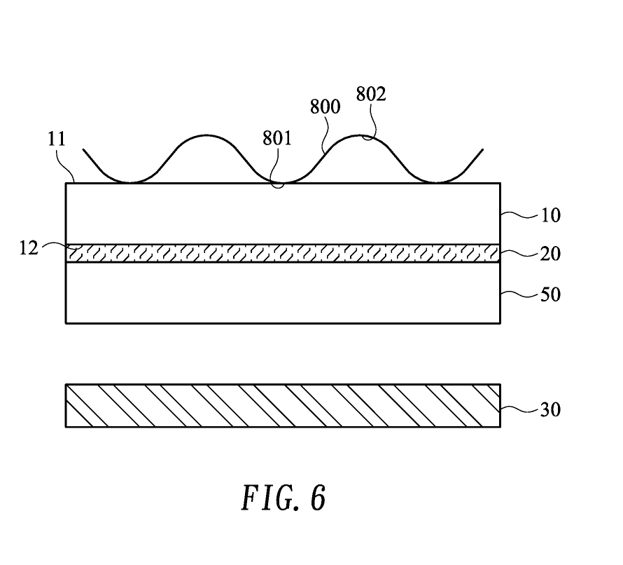

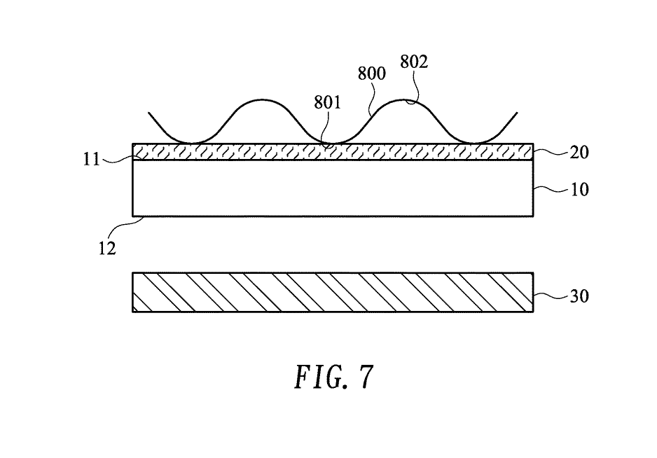

Please refer to FIG. 5 to FIG. 7, the optical sensor 30 can be implemented to not being in contact with the filter layer 20 of the sandwich type fingerprint recognition device 100 or the second transparent layer 50 of the sandwich type fingerprint recognition device 200 or the lower surface 12 of the sandwich type fingerprint recognition device 300.

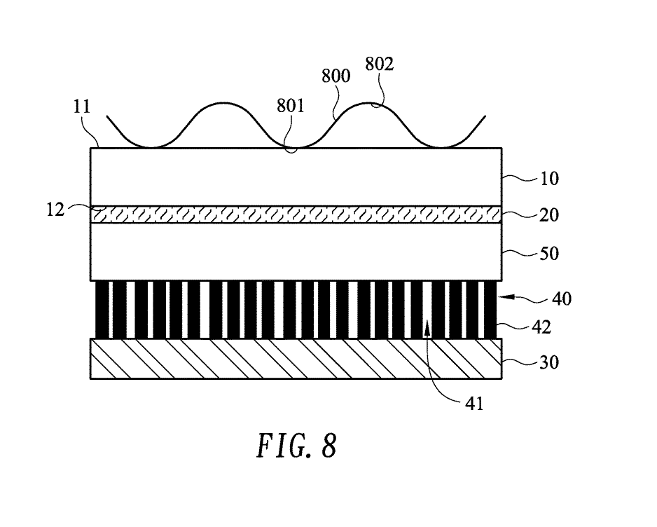

As shown in FIG. 8, a pillar layer 40 is further formed in between the second transparent layer 50 and the optical sensor 30 of the sandwich type fingerprint recognition device 200.

Wherein the pillar layer 40 can be formed by plural hollow cylinders 41, and the spacing between any two of the hollow cylinders 41 is filled with non-transparent filler material 42 with the effect that the light signal incident to the pillar layer 40 is blocked by the non-transparent filler material 42 and passes only through the hollow cylinders 41, large angle oblique incident light is thus further reduced in intensity or blocked that the contrast of the fingerprint light signal is further enhanced.

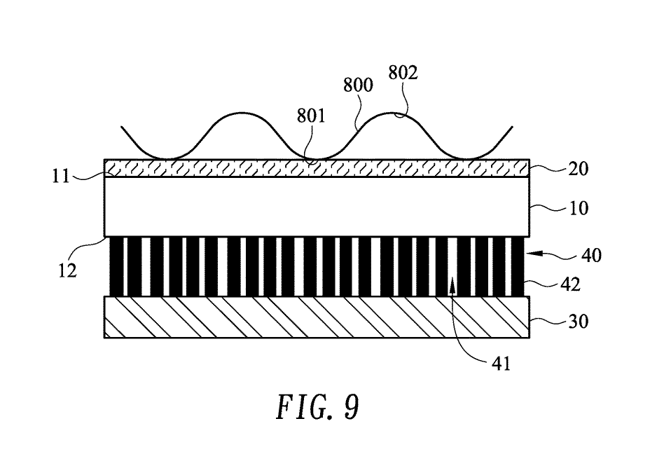

Then as shown in FIG. 9, a pillar layer 40 can further be formed in between the first transparent layer 10 and the optical sensor 30 of the sandwich type fingerprint recognition device 300.

Again, the pillar layer 40 being formed by plural hollow cylinders 41, and the spacing between any two of the hollow cylinders 41 is filled with non-transparent filler material 42 with the effect that the light signal incident to the pillar layer 40 is blocked by the non-transparent filler material 42 and passes only through the hollow cylinders 41, large angle oblique incident light is thus further reduced in intensity or blocked that the contrast of the fingerprint light signal is further enhanced.

Further, transparent material or materials can be filled inside the hollow cylinders 41 as shown in FIG. 8 and FIG. 9 to make the hollow cylinders 41 better endurable while the light can still pass through, wherein the diameter of any of the hollow cylinders 41 can be made larger than 2 μm or in between 2 μm and 100 μm.

All in all, with the implementation of the filter layer 20 in sandwich type fingerprint recognition device 100, sandwich type fingerprint recognition device 200 or sandwich type fingerprint recognition device 300, large angle oblique incident light is reduced in intensity or isolated to greatly enhance the contrast of the fingerprint light signal and thus being capable of enhancing the discrimination of characteristics of fingerprint signal and preventing false recognition.

Further with the implementation of the pillar layer 40, the benefit is further strengthened and the contrast of the fingerprint light signal in sandwich type fingerprint recognition device 200 or sandwich type fingerprint recognition device 300 is further enhanced.

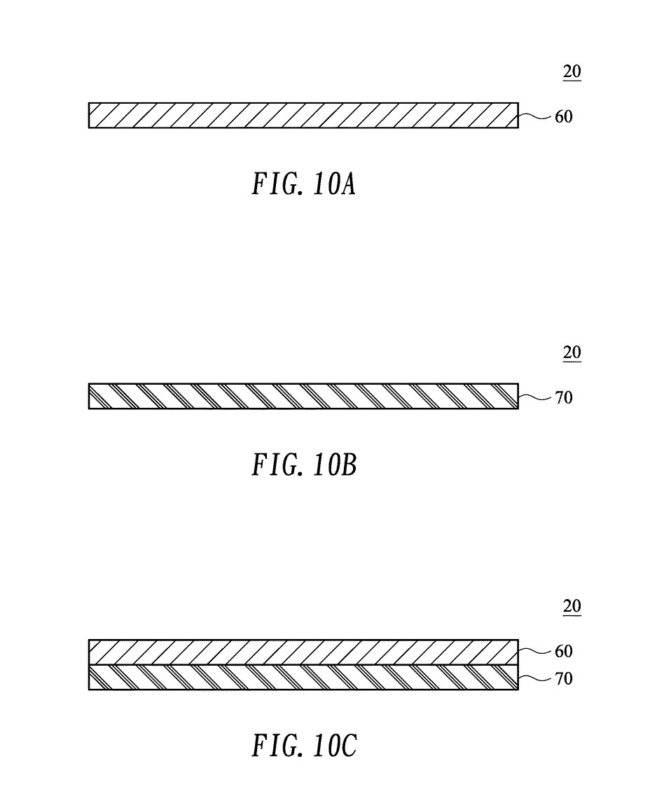

Moreover, as shown in FIG. 10A, the aforesaid filter layer 20 in the embodiments can be formed as a colored layer 60 or a replaceable colored layer 60 that makes sandwich type fingerprint recognition device 100, sandwich type fingerprint recognition device 200 or sandwich type fingerprint recognition device 300 even more widely applicable.

While as shown in FIG. 10B, the aforesaid filter layer 20 can also be formed as a spatial filter layer 70 which being an optical film, plural microstructures or a light blocking layer with plural perforated holes.

Or as shown in FIG. 10C, the aforesaid filter layer 20 can also be formed by a said colored layer 60 and a said spatial filter layer 70 altogether.

With this and as shown in FIG. 1 to FIG. 3 and FIG. 10A to FIG. 10C, the filter layer 20, being a colored layer 60, a replaceable colored layer 60 or a colored layer 60 together with a spatial filter layer, can be formed or implemented on the first transparent layer 10, or implemented in between the first transparent layer 10 and the optical sensor 30, or even implemented on the first transparent layer 10 and in between the first transparent layer 10 and the optical sensor 30 at the same time, provides the benefit of enhancing the contrast of the fingerprint light signal and thus being capable of enhancing the discrimination of characteristics of fingerprint signal and preventing false recognition.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A sandwich type fingerprint recognition device, being a multi-layer structure used to sense or recognize a fingerprint, comprising:
a first transparent layer, being made of light transmitting substance, includes an upper surface and a lower surface opposite to the upper surface, wherein the thickness of the first transparent layer is in the range from 1 micrometer to 800 micrometer;
a filter layer, being formed on the lower surface; and
an optical sensor, being fixedly provided beside the filter layer in a way that the filter layer being in between the first transparent layer and the optical sensor.

2. A sandwich type fingerprint recognition device, being a multi-layer structure used to sense or recognize a fingerprint, comprising:
a first transparent layer, being made of light transmitting substance, includes an upper surface and a lower surface opposite to the upper surface, wherein the thickness of the first transparent layer is in the range from 1 micrometer to 800 micrometer;
a filter layer, being formed on the lower surface;
a second transparent layer, being formed on the filter layer in a way that the filter layer being sandwiched in between the first transparent layer and the second transparent layer; and
an optical sensor, being fixedly provided beside the second transparent layer.

3. A sandwich type fingerprint recognition device, being a multi-layer structure used to sense or recognize a fingerprint, comprising:
a first transparent layer, being made of light transmitting substance, includes an upper surface and a lower surface opposite to the upper surface, wherein the thickness of the first transparent layer is in the range from 1 micrometer to 800 micrometer;
a filter layer, being formed on the upper surface; and
an optical sensor, being fixedly provided beside the lower surface.

4. The sandwich type fingerprint recognition device of claim 1, wherein the fingerprint being in touch with the upper surface of the first transparent layer.

5. The sandwich type fingerprint recognition device of claim 2, wherein the fingerprint being in touch with the upper surface of the first transparent layer.

6. The sandwich type fingerprint recognition device of claim 2, wherein the fingerprint being in touch with the filter layer.

7. The sandwich type fingerprint recognition device of claim 2, wherein the thickness of the second transparent layer is in the range from 1 micrometer to 800 micrometer.

8. The sandwich type fingerprint recognition device of claim 1, wherein a pillar layer is further formed in between the filter layer and the optical sensor, wherein the pillar layer being formed by plural hollow cylinders, and the spacing between any two of the hollow cylinders is filled with non-transparent filler material.

9. The sandwich type fingerprint recognition device of claim 2, wherein a pillar layer is further formed in between the second transparent layer and the optical sensor, wherein the pillar layer being formed by plural hollow cylinders, and the spacing between any two of the hollow cylinders is filled with non-transparent filler material.

10. The sandwich type fingerprint recognition device of claim 3, wherein a pillar layer is further formed in between the first transparent layer and the optical sensor, wherein the pillar layer being formed by plural hollow cylinders, and the spacing between any two of the hollow cylinders is filled with non-transparent filler material.

11. The sandwich type fingerprint recognition device of claim 1, wherein the filter layer is being a colored layer.

12. The sandwich type fingerprint recognition device of claim 2, wherein the filter layer is being a colored layer.

13. The sandwich type fingerprint recognition device of claim 3, wherein the filter layer is being a colored layer.

14. The sandwich type fingerprint recognition device of claim 1, wherein the filter layer is being a spatial filter layer which being an optical film, plural microstructures or a light blocking layer with plural perforated holes.

15. The sandwich type fingerprint recognition device of claim 2, wherein the filter layer is being a spatial filter layer which being an optical film, plural microstructures or a light blocking layer with plural perforated holes.

16. The sandwich type fingerprint recognition device of claim 3, wherein the filter layer is being a spatial filter layer which being an optical film, plural microstructures or a light blocking layer with plural perforated holes.

17. The sandwich type fingerprint recognition device of claim 1, wherein the filter layer is being a colored layer combined with a spatial filter layer, wherein the spatial filter layer being an optical film, plural microstructures or a light blocking layer with plural perforated holes.

18. The sandwich type fingerprint recognition device of claim 2, wherein the filter layer is being a colored layer combined with a spatial filter layer, wherein the spatial filter layer being an optical film, plural microstructures or a light blocking layer with plural perforated holes.

19. The sandwich type fingerprint recognition device of claim 3, wherein the filter layer is being a colored layer combined with a spatial filter layer, wherein the spatial filter layer being an optical film, plural microstructures or a light blocking layer with plural perforated holes.
